(19) United States
(12) Patent Application Publication
(10) Pub. No.: US 2025/0095028 A1
(43) Pub. Date: Mar. 20, 2025

(54) SYSTEMS AND METHODS FOR GENERATING LINEAR SYNTHETIC UNIVERSE USEFUL FOR EVALUATING MEASUREMENT ALGORITHMS

(71) Applicant: Tatari, Inc., San Francisco, CA (US)

(72) Inventors: Timothy Davies Morton, Pasadena, CA (US); Jake Patrick Reschke, Hercules, CA (US); Solomon Elkanah Klein, Berkeley, CA (US)

(21) Appl. No.: 18/889,193

(22) Filed: Sep. 18, 2024

Related U.S. Application Data
(60) Provisional application No. 63/583,500, filed on Sep. 18, 2023.

(51) Int. Cl. G06Q 30/0251

(52) U.S. Cl. CPC G06Q 30/0255

(57) ABSTRACT

Generation of synthetic data includes determining synthetic companies, synthetic rotations, and a respective response rate matrix for each synthetic company/rotation. Then, a respective actual-customer analog for each synthetic customer and a respective actual-rotation analog to each synthetic rotation are determined. To generate a synthetic data universe, a unique-visitor-per-minute UV(t) dataset over a time period for each synthetic customer is built, using UV(t) timeseries of the respective actual-customer analog and a list of linear television spots and associated data run by the respective actual-customer analog in a particular date range. The synthetic data universe thus generated includes a simulated ground truth value, which can be used to evaluate and improve a measurement algorithm.

### CROSS-REFERENCE TO RELATED APPLICATION(S)

This application claims a benefit of priority under 35 U.S.C. § 119 (e) from U.S. Provisional Application No. 63/583,500, filed Sep. 18, 2023, entitled “SYSTEMS AND METHODS FOR GENERATING LINEAR SYNTHETIC UNIVERSE USEFUL FOR EVALUATING MEASUREMENT ALGORITHMS,” the entire contents of which are hereby fully incorporated by reference herein for all purposes.

### TECHNICAL FIELD

This disclosure relates generally to data analytics. More particularly, this disclosure relates to systems and methods for programmatically generating a linear synthetic universe, useful for evaluating measurement algorithms.

### BACKGROUND OF THE RELATED ART

In the real world, determining the effectiveness of an advertising campaign of running ad spots on linear TV (i.e., traditional broadcast or cable television) requires quantifying how much the advertising campaign actually changes the behavior of users who have seen the ads on linear TV. Currently, computer systems can leverage measurement algorithms to track the number of website visitors that come to a given company's website every minute, record the time when each of the company's ad spots airs, and measure the extent to which the rate of website visitors increases in the minutes following each ad spot.

However, there is not a realistic environment in which to test whether a measurement algorithm actually measures what is happening in the real word. For instance, while the measurement algorithm can track the number of website unique visitors (UVs) that come to a given company's website every minute, the true intent of why each website visitor visits the company's website at a certain time is unknown.

Indeed, it is practically impossible, if not extremely difficult, to construct a perfectly accurate baseline for the website. One reason is that a website on the Internet can be continuously influenced by many factors in the real world. Another reason is that multiple ad spots could be airing at any given time in different places.

Accordingly, UVs could visit the website from virtually anywhere for a variety of reasons-they could be influenced to visit the website by different ad spots aired at geographically disparate locations. So, while the measurement algorithm can measure the extent to which the rate of website visitors increases in the minutes following each ad spot, there is no way to verify, after the fact, that the measurement is actually accurate.

### SUMMARY OF THE DISCLOSURE

Embodiments disclosed herein are directed to a new approach for precisely and quantitatively evaluating the accuracy of any algorithm that measures the performance (e.g., the amount of lift as compared to a baseline) of ad spots served on linear TV. Examples of such measurement algorithms can be found in U.S. Pat. Nos. 11,562,393 and 11,334,912, which are incorporated by reference herein.

Specifically, U.S. Pat. No. 11,562,393 describes a baseline/lift algorithm that can estimate the number of incremental website visitors due to each ad spot and determine a baseline from a unique visitor (UV) curve. Once the baseline is determined, the excess visitors over the baseline within a few minutes of an ad spot airing is assigned as a lift to the spot. When multiple ad spots occur within a few minutes of each other, the lift can be assigned to each ad spot according to an attribution algorithm described in U.S. Pat. No. 11,334,912.

To precisely and quantitatively evaluate the accuracy of measurement algorithms such as those described in the above-referenced U.S. Pat. Nos. 11,562,393 and 11,334,912, embodiments disclosed herein create realistic synthetic data to simulate and capture all the most salient nuances of real data. Creating a synthetic data universe allows an objective comparison between an output from a baseline/lift measurement algorithm under evaluation and “ground truth.”

According to some embodiments disclosed herein, the realistic synthetic data thus created can be utilized to objectively determine the accuracy of a measurement algorithm, enabling, for the first time, quantitative objective comparison of different such algorithms. In some embodiments, this measurement algorithm evaluation method is tuned in many ways to imitate actual client data as closely as possible, so as to stress-test measurement algorithms in a real world setting. In this case, the term “client” refers to an entity customer of an analytics platform on which a system implements the invention operates. In this disclosure, the terms “client” and “customer” are used interchangeably.

In some embodiments, a method for generating synthetic data can include determining, by a computer operating on an analytics platform in a networked computing environment, a set of synthetic companies, a set of synthetic rotations, and a respective response rate matrix for each of the set of synthetic companies and the set of synthetic rotations. The method can further include determining a respective actual-customer analog for each synthetic customer and a respective actual-rotation analog to each synthetic rotation and then generating a synthetic data universe. Generation of the synthetic data universe can include building a unique-visitor-per-minute UV(t) dataset over a time period for each synthetic customer, using UV(t) timeseries of the respective actual-customer analog and a list of linear television (TV) spots and associated data run by the respective actual-customer analog in a particular date range.

In some embodiments, the synthetic data universe thus generated can include a list of synthetic unique visitors per minute, with a number of baseline visitors and visitors due to known lift, and a list of synthetic spots, with associated airing time, impressions, spend, response rate, creative, immediate lift, and lift. In some embodiments, the synthetic data universe comprises a set of UV(t) tables for each synthetic customer over the particular date range, and a set of ad spots per company over the particular date range, each with a ground truth number of lift visitors.

In some embodiments, determining the response rate matrix comprises determining a target match fraction, an in-market fraction, and a quality factor based on a response model. The response model models a response behavior of a population of viewers of a particular TV network or rotation to media creatives from a particular company.

In some embodiments, a simulated ground truth value from the synthetic data universe can be used in evaluating the performance of a measurement algorithm. This may comprise applying a measurement algorithm to the synthetic data universe or a portion thereof so as to produce a performance measurement of a media creative and, then, comparing the performance measurement with the simulated ground truth value from the synthetic data universe so as to generate a result. The result can be used to tune or otherwise improve the measurement algorithm.

While baseline/lift measurement algorithms are used as examples of measurement algorithms that can be evaluated through some embodiments disclosed herein, those skilled in the art appreciate that the invention disclosed herein can be adapted for evaluating various types of measurement algorithms.

One embodiment may comprise a system having a processor and a memory and configured to implement a method disclosed herein. One embodiment may comprise a computer program product that comprises a non-transitory computer-readable storage medium which stores computer instructions that are executable by a processor to perform the method disclosed herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a flow diagram that illustrates an example of a method for constructing a synthetic data universe, according to some embodiments disclosed herein.

FIG. 2A depicts a plot diagram showing by example how synthetic data provides the ground truth that facilitates the evaluation of the accuracy of a measurement algorithm, according to some embodiments disclosed herein.

FIG. 2B depicts a plot diagram showing the example of FIG. 2A is overlaid with a media plan, with each vertical line representing a spot that aired at a particular time, according to some embodiments disclosed herein.

FIG. 3 shows an example of a synthetic unique visitor profile as compared to a matched real customer unique visitor profile, according to some embodiments disclosed herein.

FIG. 4 depicts a plot diagram showing an example of a synthetic baseline generated based on a previously measured baseline for an actual customer, according to some embodiments disclosed herein.

FIG. 5 depicts a plot diagram that shows measured vs. true values of lift for each spot per customer, and the total aggregate measured lift accuracy for different categories of customers, grouped by coarse baseline and response rate characteristics, according to some embodiments disclosed herein.

FIG. 6 depicts a diagrammatic representation of an example of an interactive user-facing application for exploring a synthetic data universe, according to some embodiments disclosed herein.

FIG. 7 depicts a diagrammatic representation of an example of a user interface that shows a comparison between simulated unique visitors and real customer's traffic, according to some embodiments disclosed herein.

FIG. 8 depicts a diagrammatic representation of an example of a user interface that shows a measured lift plotted against a simulated lift for every spot in a simulated customer's media plan, according to some embodiments disclosed herein.

FIG. 9 is a flow diagram that illustrates an example of a method for evaluating a measurement algorithm, according to some embodiments disclosed herein.

FIG. 10 depicts a diagrammatic representation of a data processing system for implementing a method according to some embodiments disclosed herein.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

As alluded to above, currently, there is not a realistic way to quantitatively determine whether a measurement algorithm accurately measures what is happening in the real word. For example, typically, a TV spot that aired immediately prior to a unique visitor (UV) spike to a website can be considered to have attributed to the UV spike. This UV spike can be measured by a server machine hosting the website. The integration under this spike is called a “lift,” which is based on the difference between the actual number of UVs and a “baseline.” Here, the term “baseline” refers to a UV curve for the website without any TV spot airing.

To accurately measure the efficacy of a TV spot, the baseline should be accurate. However, it is practically impossible, if not extremely difficult, to construct an accurate baseline for the website as it is not possible to ascertain the true intent of why each website visitor visits the website at a certain time. This makes it impossible to construct an accurate baseline. That is, there is no way to establish ground truth when it comes to website visitor data.

In machine learning, the term “ground truth” refers to the real world data used in training and testing machine learning model outputs. Recognizing that ground truth may not be established using the real world data in terms of website visitors, embodiments disclosed herein construct a synthetic data universe with synthetic data that capture all the most salient nuances of the real world data. In this synthetic data universe, ground truth can be established and verified. Accordingly, in this disclosure, the term “ground truth” refers to information that is known to be real or true in the synthetic data universe.

The synthetic data universe is constructed to mimic all that is possible in the real world. For this reason, it can be considered as a linear synthetic universe. As described below, the term “linear” is used to describe the construction of the synthetic data universe as a mapping process in which various types of data of actual companies (which are referred to hereinafter as “customers”) in the real world are used to map out and generate corresponding types of data of synthetic customers in the synthetic data universe.

### Synthetic Data

In general, predictive models are trained and evaluated by comparing the predictions of a model to actual historical values of the exact quantity that the model is trying to predict. However, as alluded to above, a measurement algorithm like the spot-lift algorithm attempts to measure something for which the precise truth is not identifiable, even in retrospect.

For instance, while for each ad spot there does exist some true number of people who saw a TV ad and visited the customer's website shortly thereafter, that true number is not actually practically knowable by any method short of omniscience. As a result, while an algorithm to measure a lift may be thought clever, well-justified, or intuitive, its accuracy cannot be quantitatively evaluated in the same way that a predictive regression model can be, due to the lack of a known ground truth.

Synthetic data can ameliorate this situation. If realistic data can be simulated with sufficient fidelity, capturing all the most salient nuances of real data, this can allow comparison of measurement to ground truth in a way that is not possible otherwise.

The invention disclosed herein provides a method for generating realistic synthetic data in such a way as to objectively measure the accuracy of any baseline/lift measurement algorithm, enabling for the first time quantitative objective comparison of different such algorithms. As described below, this method is carefully tuned in many ways to imitate actual customer data as closely as possible, in order to stress-test measurement algorithms in a real world setting.

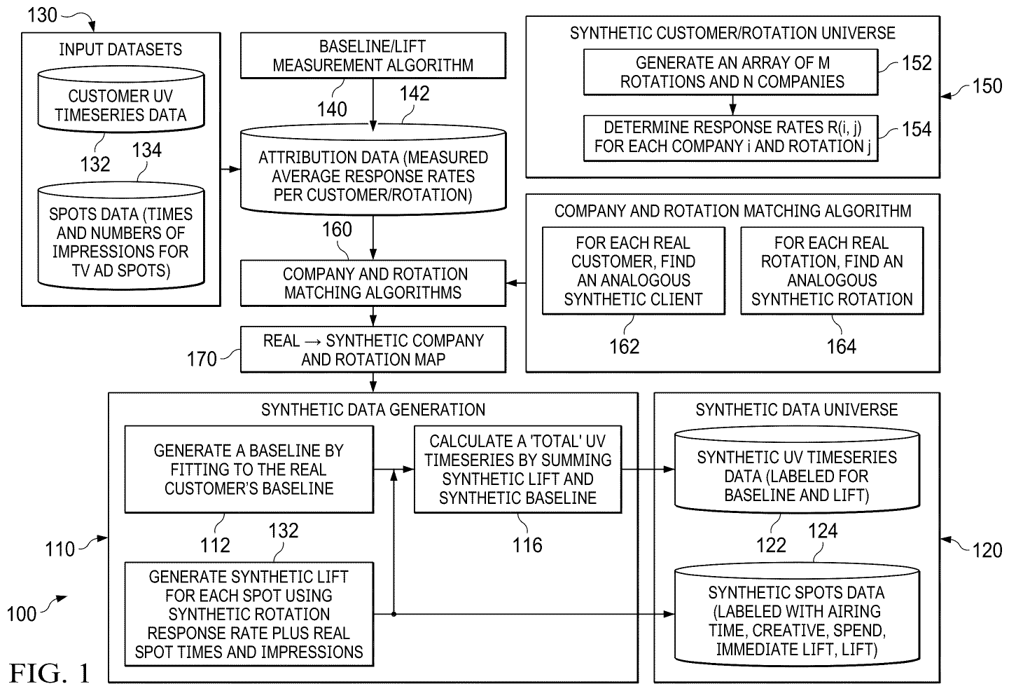

FIG. 1 is a flow diagram that illustrates an example of a method 100 for constructing a synthetic data universe 120, according to some embodiments disclosed herein.

### Synthetic Data Universe: Algorithm Overview

In some embodiments, the synthetic data universe 120 is generated based on a model of ad response: when an individual sees an ad aired on linear TV, they have a probability p of responding to that ad by taking some action that can be measured as an event, such as visiting a customer's website. However, every individual will have a different p and, therefore, a useful aggregation approach is to consider the response behavior of a population of viewers of a particular TV network/rotation to ads from a particular company.

This aggregation approach can be summarized by a response rate matrix Rᵢⱼ, of which each element is the average response rate of the viewers of rotation j to an ad spot from company i. The initial building blocks of this synthetic universe are thus a set of companies, a set of rotations, and this response rate matrix Rᵢⱼ. The final output of this simulation (i.e., the synthetic data universe) is a set of unique-visitor-per-minute (UV(t)) tables for each synthetic company over a particular range of time, and a set of ad spots per company over that time range, each with a ground truth number of “lift” visitors.

Accordingly, in some embodiments, a synthetic data generation algorithm 110 is configured by performing the following steps:
constructing a response rate matrix Rᵢⱼ (150);
identifying customer and rotation analogs, including assigning a real-customer analog to each synthetic customer and a real-rotation analog to each synthetic rotation (160); and
generating the synthetic data universe 120 by building a UV(t) dataset over a chosen time period for each synthetic customer, including:
   generating a baseline rate modeled after the actual analog customer's measured baseline in the chosen time period, and using the baseline rate to randomly generate a number of baseline visitors every minute (112);
   selecting ad spots for the customer to air by duplicating the analog customer's actual media plans in the chosen time period (170);
   generating lift-visitors for each spot based on the number of viewers of that spot (“impressions”), the response rate for that customer-rotation pair, and an assumed lift-response profile (which includes the distribution of time lag between when a spot airs and when a responding viewer's action is taken) (114); and
   generating the synthetic UV(t) dataset for the customer by summing the simulated baseline 112 and lift visitors 114 in each minute of the chosen time period (116).
   These steps are further described in detail below.

### Constructing a Response Rate Matrix

The synthetic data universe consists of a number N synthetic customers and a number M synthetic rotations, where N and Mare user defined inputs (152). The output of this step of the method 100 is a synthetic response rate for each customer-rotation pair (154). The process which generates these response rates is determined by several parameters, which can be tuned to match the distribution of synthetic response rates to the distribution of measured response rates of real customers. These parameters can vary from implementation to implementation.

In some embodiments, the response rate matrix can be modeled as having three components or factors as follows:

Rᵢⱼ=Tᵢⱼ·fᵢ·Qᵢ
Target match fraction Tᵢⱼ: the fraction of a rotation's audience that matches a company's target demographic
In-market fraction fᵢ: the fraction of a company's target demographic who is in the market for the company's product at any given time, and
Quality factor Qᵢ: a multiplicative factor for response rate quantifying the quality of the marketing.

### Target Match Fraction

For the target match fraction matrix, a correlated distribution of random numbers is generated with the following procedure:
creating an N by 1 vector x by drawing N numbers xᵢ, where each xᵢ˜U(l, h)^{α}, and sorting them:

x=sorted (xᵢ)
creating an M by 1 vector y by drawing M numbers yᵢ, where each yᵢ˜U(l, h)^{α}, and sorting them:

y=sorted (yᵢ)
obtaining the target match matrix T as the outer product of these vectors:

T=xy^{T}

Here, the values l, h, and α in these equations are user-configurable parameters and U(l, h) represents the uniform random variable on the interval [l, h]. The user-configurable parameters may vary from implementation to implementation.

### In-Market Factor

For the in-market factor, random values are drawn for each customer from a log-uniform distribution, with the following procedure:
drawing N numbers vᵢ from a log-normal distribution:

ln(vᵢ)˜U(α, b)
creating the in-market factor as an N dimensional vector ƒ with components ƒᵢ=vᵢ/52

The numbers vᵢ represent the number of times per year that a consumer might make a purchase of the type the company is marketing. The in-market factor is then the estimated fraction of consumers that would be “in-market” in a given week, assuming that purchase frequency. Here, the values α and b are user-configurable parameters, which may vary from implementation to implementation.

### Marketing Quality Factor

A marketing quality factor Qᵢ is drawn for each customer based on a log-normal distribution centered on 0 (in log-space, representing a quality factor of 1), with standard deviation 0.5:

ln(Qᵢ)˜N(0,1/4)

This results in most customer quality factors landing between 3 and ⅓, and most often close to one.

Once these parameters are set, the method 100 performs without human intervention.

### Identifying Customer and Rotation Analogs

The number of synthetic customers in a synthetic customer/rotation universe 150 may be different in different embodiments. For example, a synthetic customer/rotation universe may contain only one customer (N=1) or many. However, in practice, to effectively evaluate a measurement algorithm, the number N should be sufficiently large to capture a wide range of customer types.

Some customers may have hundreds of UVs per minutes, while others may have a few UVs per minute. Some customers may have very discrepant ways in which they purchase media creatives to air on linear TV. For instance, some may purchase very expensive spots and some may purchase spots to air at much smaller TV networks.

A goal here is to have enough synthetic customers to cover the characteristics, including different traffic patterns and different media creative buying patterns, of real customers for which measurements are taken. In this way, a small set of synthetic customers (e.g., 10-20) may cover a wide range of different kinds of customers over a time window (e.g., three months at a time). Different embodiments may cover different time periods (durations of time, for instance, daily, weekly, etc.

Once a set of synthetic customers, synthetic rotations, and their respective response-rate matrix are defined, a matching algorithm 160 determines an actual-customer analog to each synthetic customer and an actual-rotation analog to each synthetic rotation (162). For customers, the matching algorithm 160 first identifies, from a database 142 that stores customer data including UVs to a customer's website 132 and the customer's media plan 134, the top N customers by spend within the timeframe for the simulation.

As a non-limiting example, a value of N can be N=100. For each of these N customers, the synthetic data universe algorithm identifies a synthetic customer whose mean synthetic response rate (across synthetic rotations) most closely matches a measured average response rate over that time period (measured by a measurement algorithm).

For rotations, the top M rotations are selected from the database by total spend. Each of these actual rotations is randomly assigned to a synthetic rotation (164). As a non-limiting example, a value of M can be M=1000.

### Building a UV(T) Dataset (Synthetic Data Universe) for a Synthetic Customer

In some embodiments, input datasets 130 to a synthetic data generation algorithm 110 for a single customer include:
the UV(t) timeseries of the real customer, along with the baseline measurement 132;
the list of linear TV spots and associated data run by the matched real customer in a particular date range 134; and
the response rate matrix Rᵢⱼ 154, which is stored in the database 142.

With each synthetic customer 162 and rotation 164 matched to a real counterpart (i.e., an actual customer) through the matching algorithm 160, the UV(t) timeseries for each synthetic customer 132 and the media plan (which specifies what exact spot runs at what time for what rotation for a particular customer) 134 can be constructed. A map 170 of how the real customer maps to the synthetic customer, with respect to company and rotation, is provided as input to the synthetic data generation algorithm 110.

In some embodiments, outputs from the synthetic data generation algorithm 110 for the single customer include:
a list of synthetic unique visitors per minute, with the number of baseline visitors and visitors due to lift exactly known (122); and
a list of synthetic spots, with associated airing time, impressions, spend, response rate, creative, immediate lift, and lift (124).

In some embodiments, optionally, one or more baseline/spot lift measurement algorithms 140 can be run on the synthetic data to gauge the accuracy of the measurement algorithm 140.

### Simulations/Building Blocks for Generating Synthetic Data

### Media Plan Simulation

To generate realistic media plans for synthetic customers, the media plan of a matched real (analog) customer can be used. Some embodiments take all the spots for the analog customer within a chosen timeframe that aired on any of the M rotations that were matched to the synthetic set of rotations. The result is a collection of spots with very realistic spend patterns and distribution of airing times. Each rotation in the collection is assigned the synthetic response rate determined by the customer-rotation response rate algorithm.

### Baseline Simulation

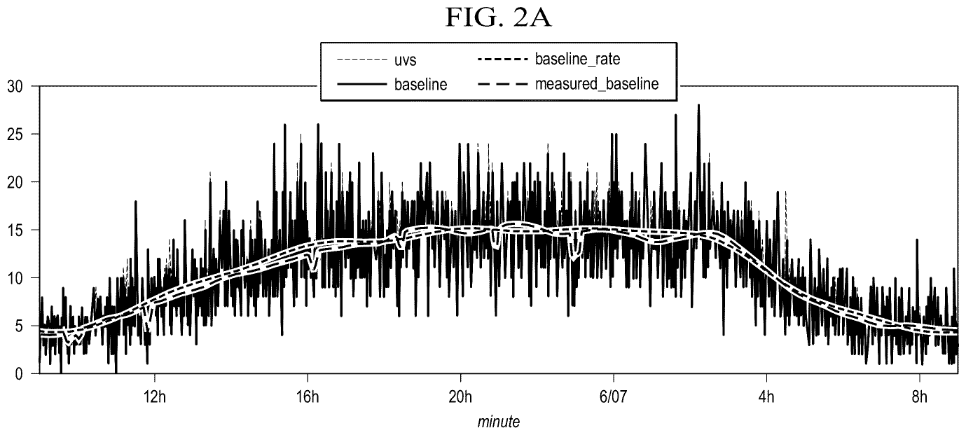

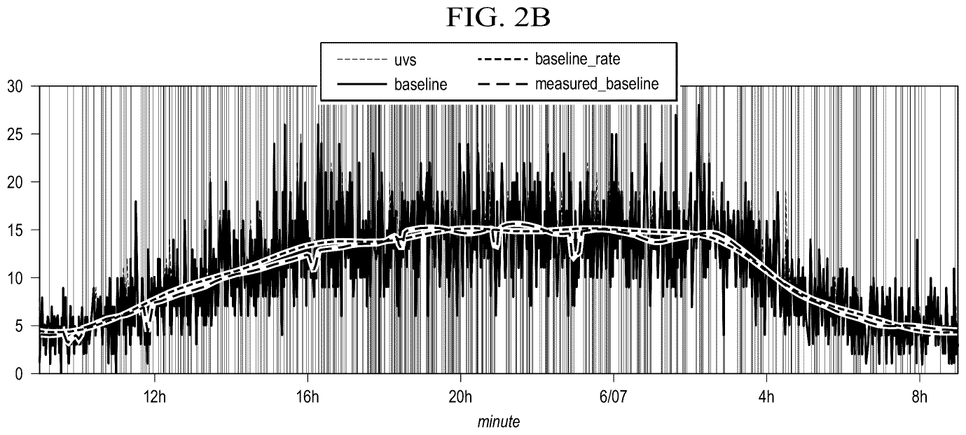

Some embodiments simulate an expected number of baseline visitors for each minute by fitting a smooth, periodic function to a measured baseline for the underlying real customer (as measured by a measurement algorithm) (112). FIG. 2A depicts a plot diagram showing an example of synthetic data output for a single customer with a measured baseline.

In some embodiments, modifications can be made if one of the following scenarios holds:
1. There are significant changes in the amplitude of the real customer's UV profile; or
2. The real customer's UV profile is very sparse, meaning that it contains many 0's.

In case of the first scenario, a variable amplitude fit can be used. In the case of the second scenario, the measured baseline is ignored and, instead, fit to a single week UV profile constructed from UV values outside of a time window (e.g., 8 minutes) around each spot.

### Spot Response Simulation

To simulate a response due to a spot, the lift of the spot (i.e., how many viewers responded to the spot) and the response profile of the spot (when these responders take action) are simulated separately. FIG. 2B depicts a plot diagram showing the example of FIG. 2A, with a media plan in which each vertical black line represents a spot that aired at a particular time.

The spot response profile algorithm takes an assumed distribution of when UVs resulting from the ad will arrive. This distribution is used to compute the proportion of the visitors that arrive within each minute after the spot airs. This procedure takes into account the second value of the spot's airing time, and distinguishes between immediate responders (those who respond within 5 minutes of the airing time) and delayed responses (those who take more than 5 minutes to respond).

The spot lift measurement algorithm determines the expected number of visitors from the impressions and response rate of the spot. The response rate of the spot is drawn from a distribution determined by the spot's rotation response rate for the synthetic customer/rotation pair and the spread of measured spot level response rates for the real customer.

Adjustment factors related to the time of day the spot airs and the particular media creative are applied (e.g., based on domain knowledge). Immediate and delayed responders are distinguished, as in the response profile algorithm. The expected number of UVs in each minute after the spot airs are determined using the proportions calculated from the response profile and the total number of expected UVs.

This results in an expected number of lift-generated visitors in each minute following a spot. A true number of lift-generated visitors in each of these minutes can then be drawn from a Poisson distribution of which the rate parameter in each minute is given by this expected rate. Simulation outputs are then persisted and configurations stored.

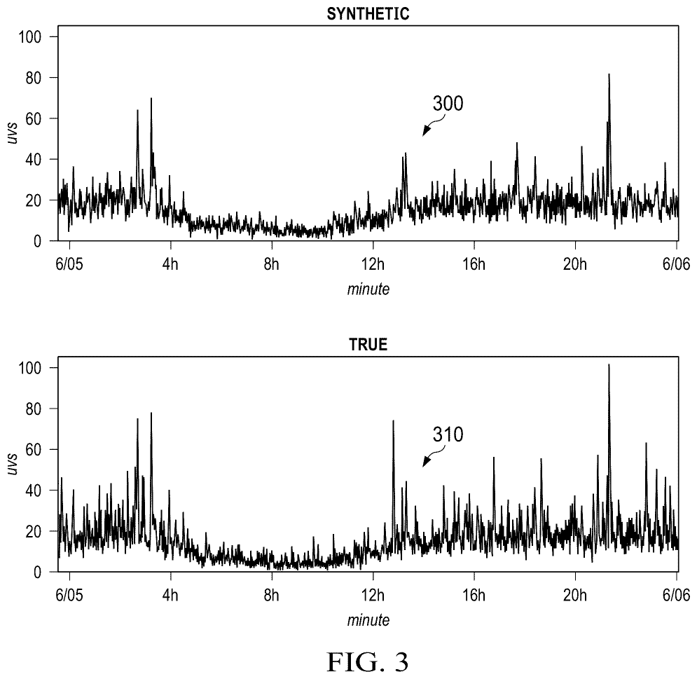

Repeating the above procedure for every spot in the synthetic customer's dataset simulates all lift-generated visitors in each minute, keeping track of which visitors came due to which spot. FIG. 3 shows an example of a synthetic UV profile 300 as compared to a matched real (i.e., “true”) customer UV profile 310. Adding these visitors to the previously simulated baseline visitors results in the full dataset that can be fed into a measurement algorithm.

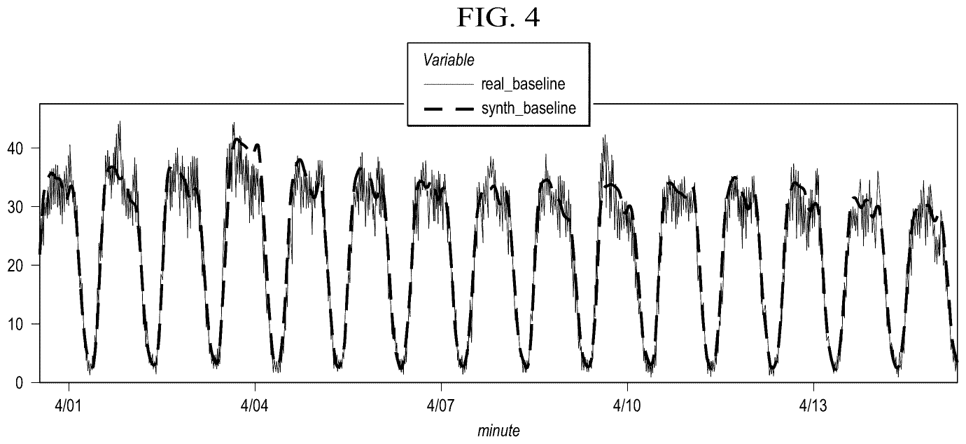

FIG. 4 depicts a plot diagram showing an example of a synthetic baseline generated from the measured baseline. The result is a synthetic baseline rate of UVs in each minute of the simulation. In order to turn this into a UV(t) dataset for baseline visitors, some embodiments draw from a Poisson distribution, with the rate in each minute given by this synthetic baseline rate. As alluded to above, there is no way to verify the ground truth of the “real baseline” shown in FIG. 4. However, the synthetic baseline is verifiable through the synthetic data.

### Using Synthetic Data for Measurement Validation

The overall result of the synthetic data universe simulation described above is UV(t) timeseries data for each of the N customers over a chosen time frame (e.g., three months of data), and the ground truth values of lift per spot. The UV(t) data is in exactly the form that the baseline/lift measurement algorithms take as input, so this data can be fed through a measurement algorithm and compare the measured spot lift values to the recorded ground truth values.

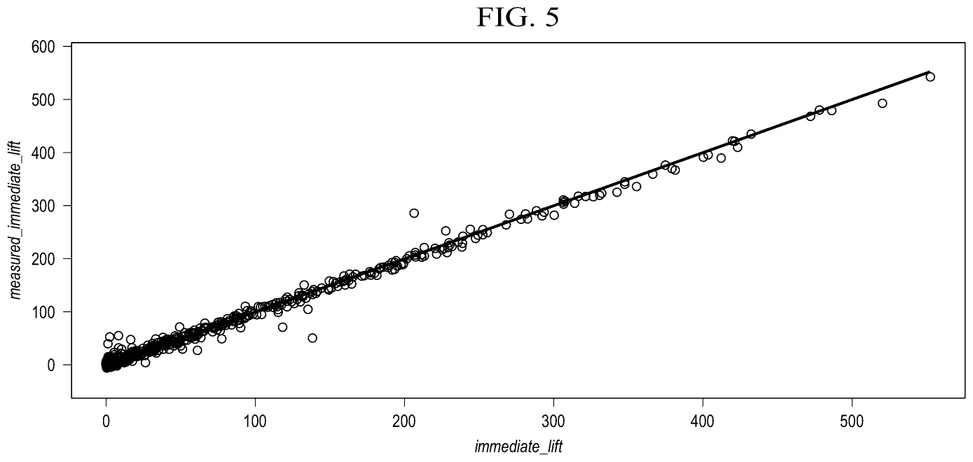

FIG. 5 depicts a plot diagram that demonstrate this in action, showing measured vs. true values of lift for each spot for one customer, and the total aggregate measured lift accuracy for different categories of customers, grouped by coarse baseline and response rate characteristics.

In Table 1 below, the total aggregate measured lift for all customers in a simulation described herein is expressed as a percentage of the true lift. This demonstrates how the methods disclosed herein can be used to identify potential improvements in measurement algorithms.

TABLE 1

| | Sparse | Low | Medium | High |
|---|---|---|---|---|
| rr_category | Baseline | Baseline | Baseline | Baseline |
| Low | 104.433992 | 105.595549 | 91.590552 | 82.150004 |
| Medium | 101.202927 | 94.461462 | 83.156854 | 79.417268 |
| High | 97.190687 | 94.552007 | 81.824064 | 87.44192 |

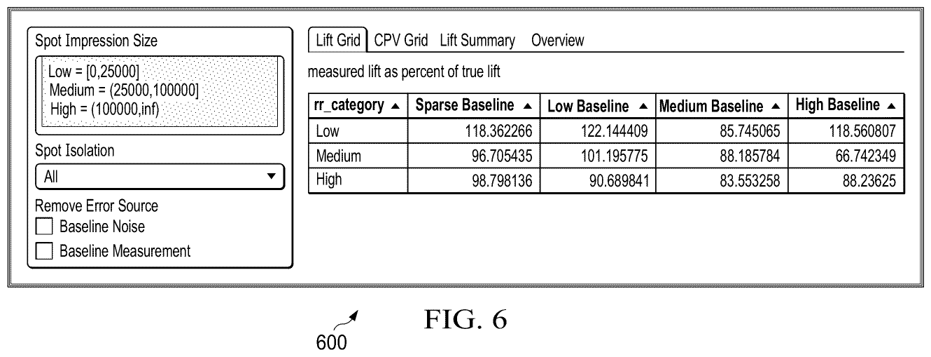

In some embodiments, users also have the option to, through an interactive display, select and visualize results for a single customer in the simulation. Examples are shown in FIG. 6-8, which depict diagrammatic representations of various views of an interactive user-facing application for exploring a synthetic data universe.

FIG. 6 depicts a diagrammatic representation of an example of a user interface 600 that shows which data in the synthetic data universe is available to view and which parameters were used to generate the data. The user interface 600 allows for the user to choose different visualization options.

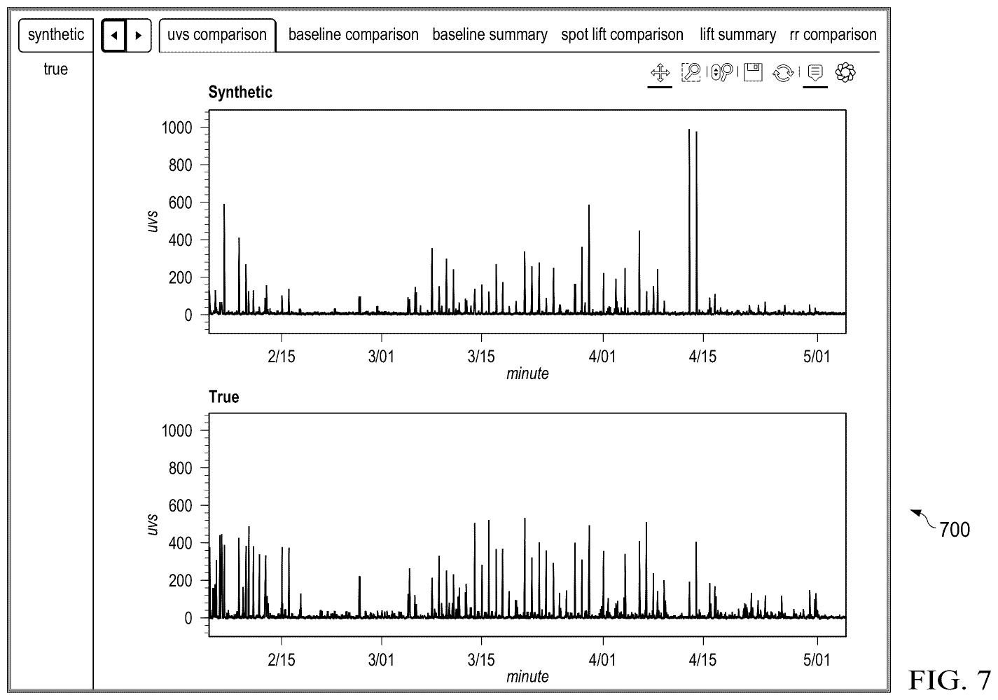

FIG. 7 depicts a diagrammatic representation of an example of a user interface 700 that shows a comparison of the simulated UVs to the real customers traffic. The user interface 700 can be provided by a synthetic data exploration application hosted on an analytics platform. As a non-limiting example, the analytics platform may also provide measurement algorithms for measuring the performance of media creatives across linear TV networks.

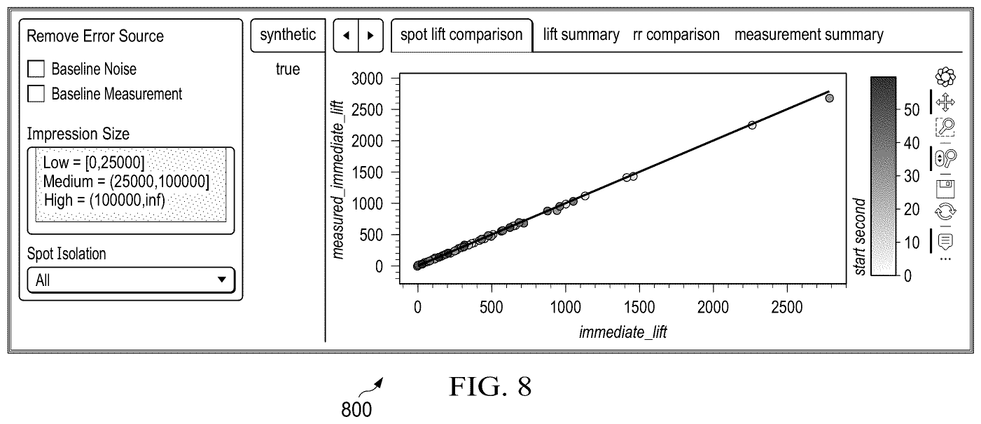

FIG. 8 depicts a diagrammatic representation of an example of a user interface 800 that shows a measured lift plotted against a simulated lift for every spot in a simulated customer's media plan. Through the user interface 800, the synthetic data exploration application allows the user to filter which spots are displayed based on different criteria, and it allows for certain error sources to be independently removed in order to gauge their impact on measurement accuracy.

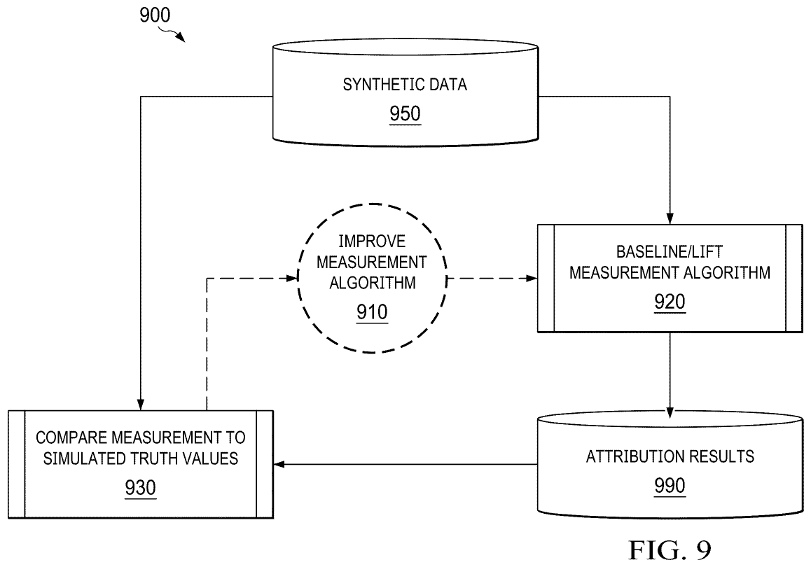

FIG. 9 is a flow diagram that illustrates an example of a method 900 for evaluating a measurement algorithm 920 utilizing synthetic data 950, according to some embodiments disclosed herein. The synthetic data 950 can be part of the synthetic data universe 150 described above. The measurement algorithm 920 can be any suitable measurement algorithm that measures the performance of a media creative in generating a lift in the number of UVs of a website within a timeframe.

As a non-limiting example, the measurement algorithm 920 takes the synthetic data 950 as input, measures the performance of a media creative in the synthetic data 950 as described in the above-referenced U.S. Pat. No. 11,562,393, and outputs attribution results 990 as described in the above.

As illustrated in FIG. 9, a measurement algorithm evaluation process 930 is operable to compare the measurements in the attribution results 990 with the simulated ground truth provided by the synthetic data 950. The measurement algorithm evaluation process 930 outputs a result 910, which comprises a difference between the measurements in the attribution results 990 and the simulated ground truth. Optionally, the result 910 can be used to improve the measurement algorithm 920. The measurement algorithm evaluation process 930 can be iteratively performed to continuously fine-tune/improve the measurement algorithm 920.

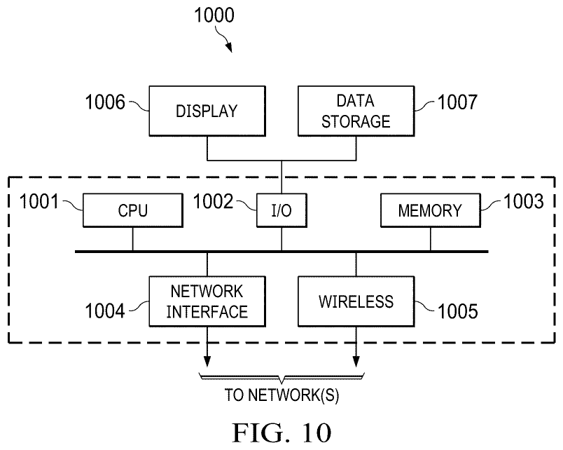

FIG. 10 depicts a diagrammatic representation of a data processing system for implementing an embodiment disclosed herein. As shown in FIG. 10, a data processing system 1000 may include one or more central processing units (CPU) or processors 1001 coupled to one or more user input/output (I/O) devices 1002 and memory devices 1003. Examples of I/O devices 1002 may include, but are not limited to, keyboards, displays, monitors, touch screens, printers, electronic pointing devices such as mice, trackballs, styluses, touch pads, or the like.

Examples of memory devices 1003 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 1000 can be coupled to display 1006, information device 1007 and various peripheral devices (not shown), such as printers, plotters, speakers, etc. through I/O devices 1002. Data processing system 1000 may also be coupled to external computers or other devices through network interface 1004, wireless transceiver 1005, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein.

The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively or additionally, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including Python. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures in the accompanying appendices can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. The scope of the present disclosure should be determined by the following claims and their legal equivalents.

What is claimed is:

1. A method for generating synthetic data, the method comprising:
determining, by a computer operating on an analytics platform in a networked computing environment, a set of synthetic companies, a set of synthetic rotations, and a respective response rate matrix for each of the set of synthetic companies and the set of synthetic rotations;
determining, by the computer, a respective actual-customer analog for each synthetic customer and a respective actual-rotation analog to each synthetic rotation; and
generating, by the computer, a synthetic data universe, the generating comprising building a unique-visitor-per-minute UV(t) dataset over a time period for each synthetic customer, using UV(t) timeseries of the respective actual-customer analog and a list of linear television (TV) spots and associated data run by the respective actual-customer analog in a particular date range.

2. The method according to claim 1, wherein the synthetic data universe comprises, for each synthetic customer:
a list of synthetic unique visitors per minute, with a number of baseline visitors and visitors due to known lift; and
a list of synthetic spots, with associated airing time, impressions, spend, response rate, creative, immediate lift, and lift.

3. The method according to claim 1, wherein determining the response rate matrix comprises determining a target match fraction, an in-market fraction, and a quality factor based on a response model that models a response behavior of a population of viewers of a particular TV network or rotation to media creatives from a particular company.

4. The method according to claim 1, wherein the synthetic data universe comprises a set of UV(t) tables for each synthetic customer over the particular date range, and a set of ad spots per company over the particular date range, each with a ground truth number of lift visitors.

5. The method according to claim 1, further comprising:
applying a measurement algorithm to the synthetic data universe or a portion thereof so as to produce a performance measurement of a media creative; and
comparing the performance measurement with a simulated ground truth value from the synthetic data universe so as to generate a result.

6. The method according to claim 5, further comprising:
tuning the measurement algorithm based on the result so as to improve the measurement algorithm.

7. The method according to claim 1, further comprising:
generating a media plan for each synthetic customer using a media plan of the respective actual-customer analog such that the media plan for each synthetic customer contains spots with realistic spend patterns and distribution of airing times that mimic the media plan of the respective actual-customer analog.

8. A system for generating synthetic data, the system comprising:
a processor;
a non-transitory computer-readable medium; and
instructions stored on the non-transitory computer-readable medium and translatable by the processor for:
determining a set of synthetic companies, a set of synthetic rotations, and a respective response rate matrix for each of the set of synthetic companies and the set of synthetic rotations;
determining a respective actual-customer analog for each synthetic customer and a respective actual-rotation analog to each synthetic rotation; and
generating a synthetic data universe, the generating comprising building a unique-visitor-per-minute UV(t) dataset over a time period for each synthetic customer, using UV(t) timeseries of the respective actual-customer analog and a list of linear television (TV) spots and associated data run by the respective actual-customer analog in a particular date range.

9. The system of claim 8, wherein the synthetic data universe comprises, for each synthetic customer:
a list of synthetic unique visitors per minute, with a number of baseline visitors and visitors due to known lift; and
a list of synthetic spots, with associated airing time, impressions, spend, response rate, creative, immediate lift, and lift.

10. The system of claim 8, wherein determining the response rate matrix comprises determining a target match fraction, an in-market fraction, and a quality factor based on a response model that models a response behavior of a population of viewers of a particular TV network or rotation to media creatives from a particular company.

11. The system of claim 8, wherein the synthetic data universe comprises a set of UV(t) tables for each synthetic customer over the particular date range, and a set of ad spots per company over the particular date range, each with a ground truth number of lift visitors.

12. The system of claim 8, wherein the instructions are further translatable by the processor for:
applying a measurement algorithm to the synthetic data universe or a portion thereof so as to produce a performance measurement of a media creative; and
comparing the performance measurement with a simulated ground truth value from the synthetic data universe so as to generate a result.

13. The system of claim 12, wherein the instructions are further translatable by the processor for:
tuning the measurement algorithm based on the result so as to improve the measurement algorithm.

14. The system of claim 8, wherein the instructions are further translatable by the processor for:
generating a media plan for each synthetic customer using a media plan of the respective actual-customer analog such that the media plan for each synthetic customer contains spots with realistic spend patterns and distribution of airing times that mimic the media plan of the respective actual-customer analog.

15. A computer program product for generating synthetic data, the computer program product comprising a non-transitory computer-readable medium storing instructions translatable by a processor for:
determining a set of synthetic companies, a set of synthetic rotations, and a respective response rate matrix for each of the set of synthetic companies and the set of synthetic rotations;
determining a respective actual-customer analog for each synthetic customer and a respective actual-rotation analog to each synthetic rotation; and
generating a synthetic data universe, the generating comprising building a unique-visitor-per-minute UV(t) dataset over a time period for each synthetic customer, using UV(t) timeseries of the respective actual-customer analog and a list of linear television (TV) spots and associated data run by the respective actual-customer analog in a particular date range.

16. The computer program product of claim 15, wherein the synthetic data universe comprises, for each synthetic customer:
a list of synthetic unique visitors per minute, with a number of baseline visitors and visitors due to known lift; and
a list of synthetic spots, with associated airing time, impressions, spend, response rate, creative, immediate lift, and lift.

17. The computer program product of claim 15, wherein determining the response rate matrix comprises determining a target match fraction, an in-market fraction, and a quality factor based on a response model that models a response behavior of a population of viewers of a particular TV network or rotation to media creatives from a particular company.

18. The computer program product of claim 15, wherein the synthetic data universe comprises a set of UV(t) tables for each synthetic customer over the particular date range, and a set of ad spots per company over the particular date range, each with a ground truth number of lift visitors.

19. The computer program product of claim 15, wherein the instructions are further translatable by the processor for:
applying a measurement algorithm to the synthetic data universe or a portion thereof so as to produce a performance measurement of a media creative; and
comparing the performance measurement with a simulated ground truth value from the synthetic data universe so as to generate a result.

20. The computer program product of claim 15, wherein the instructions are further translatable by the processor for:
tuning the measurement algorithm based on the result so as to improve the measurement algorithm.
